(19) United States
(12) Patent Application Publication
(10) Pub. No.: US 2021/0334055 A1
(43) Pub. Date: Oct. 28, 2021

(54) METHOD OF MANUFACTURING PRINTED PRODUCTS WITH VARIANCE REDUCTION

(71) Applicant: Heidelberger Druckmaschinen AG, Heidelberg (DE)

(72) Inventors: Bernhard Wagensommer, Malsch (DE); Rainer Wolf, Stuttgart (DE); Frank Kropp, Mauer (DE); Gottfried Grasl, Angelbachtal (DE); Dominic Stahl, Mauer (DE); Georg Roessler, Angelbachtal (DE); Juergen Grimm, Frankfurt (DE)

(21) Appl. No.: 17/242,416

(22) Filed: Apr. 28, 2021

(30) Foreign Application Priority Data
Apr. 28, 2020 (EP) 20171731.1

(51) Int. Cl. G06F 3/12

(52) U.S. Cl. CPC G06F 3/1262; G06F 3/1296; G06F 3/1211; G06F 3/1287; G06F 3/1293

(57) ABSTRACT

A method of manufacturing printed products from print job requests includes supplying a computer with job forecasts of print jobs through at least one interface and preferences of a print shop through the interface or a further interface. The computer uses an exclusion filter to filter out non-matching print jobs by comparing the preferences of the print shop with the job forecasts and, based on non-excluded print jobs, creates preference classes for print jobs, receives data of print job requests through the interface, compares the data of the print job requests to the calculated preference classes of the print jobs to filter out non-matching print job requests, and forwards only remaining, matching print job requests to a production machine of a print shop, which accepts the print job requests as print jobs and processes them on the production machine to manufacture the printed products.

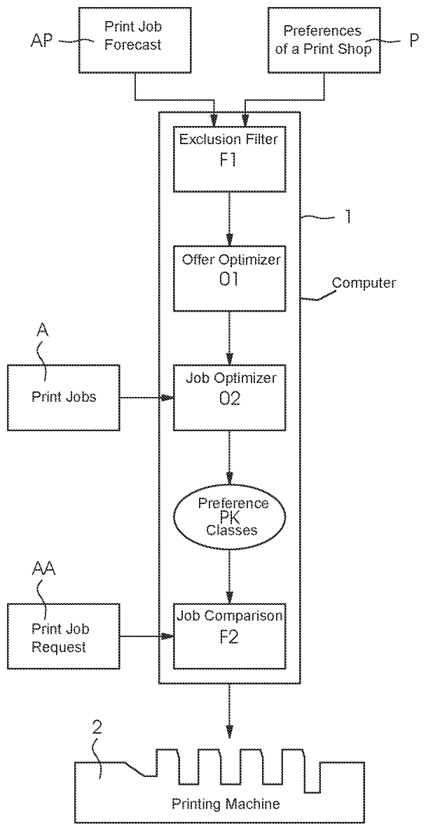

### CROSS-REFERENCE TO RELATED APPLICATION

This application claims the priority, under 35 U.S.C. § 119, of European Patent application EP 20171731.1, filed Apr. 28, 2020; the prior application is herewith incorporated by reference in its entirety.

### BACKGROUND OF THE INVENTION

### Field of the Invention

The present invention relates to a method of manufacturing printed products from print job requests by using at least one computer and at least one production machine, in which the computer is fed job forecasts of print jobs through at least one interface and the computer is fed preferences of a print shop through one or another interface.

The present method concerns optimizing the print production process for print shops in such a way that the print shops receive print jobs that match their profiles as much as possible. Many print shops have a difficult time assessing which print jobs and printed products it makes sense for them to offer. Thus, either they offer printed products which they cannot produce at a profit or they miss many opportunities to accept jobs because they are afraid of being unable to produce them at a profit.

### BRIEF SUMMARY OF THE INVENTION

It is accordingly an object of the invention to provide a method of manufacturing printed products with variance reduction, which overcomes the hereinafore-mentioned disadvantages of the heretofore-known methods of this general type.

Against that background, an object of the present invention is to provide a method of manufacturing printed products from print jobs, in which the method limits variations of a plurality of print job requests to amounts that may expediently be processed by a print shop. The method in particular factors in the technical capabilities and limitations of the print shop in the form of the machinery and consumables that are available at the print shop, but also the skills of the operating staff, because some complex and demanding print jobs may require specially trained staff.

With the foregoing and other objects in view there is provided, in accordance with the invention, a method of manufacturing printed products from print job requests by using at least one computer and at least one production machine, in which the computer uses an exclusion filter to filter out non-matching print jobs by comparing the preferences of a print shop to the job forecasts and, on the basis of the non-excluded print jobs, creates preference classes for print jobs, the computer receives data of print job requests through the at least one interface and compares the data of the print job requests to the calculated print job preference classes to filter out non-matching print job requests. In addition, the computer only forwards the remaining matching print job requests to the at least one printing press of the print shop. The print shop may then accept these print job requests as orders and process and produce them as print jobs on the printing machine.

In the context of the present invention, job forecasts are understood to be forecasts of expected future print jobs, while preferences are understood to be the technical, economic, and human resources available in a print shop. The preferences further include the cost structure of the print shop because it does not make sense for a print shop to accept print jobs that the print shop is capable of processing from a technical point of view but not from an economic point of view. The technical method of the invention is preferably implemented as software on a computer, which may be in the form of a centralized configuration such as an Internet platform or in the form of a decentralized configuration. In the case of a centralized configuration, the computer expediently communicates with the connected participants of one or more print shops through an internet connection. In addition, there are interfaces with customers to collect print job requests made by the customers and to receive data on job forecasts. The computer may be part of a cloud-based platform solution on the Internet. The first step it takes is to compare the preferences of a print shop with the job forecasts by applying an exclusion filter. Thus, those print jobs among the job forecasts that are incompatible with the preferences of the print shop are filtered out in advance. The print jobs that have not been excluded on this basis are used to create preference classes which include all non-excluded print jobs. Moreover, when preference classes are created, print jobs are clustered, i.e. similar print jobs, for example ones with similar printing substrates, similar colors, or similar processing steps are clustered in corresponding classes, factoring in technically expedient tolerances such as a maximum allowable deviation concerning the printing substrate weight in % or grams. This reduces the number of preference classes and makes their application to the preference classes to future print jobs easier to handle.

The computer may additionally receive actual print job orders or print jobs already prepared for production from customers through an interface and may in turn compare them to the preference classes of the print jobs and filter out preference classes that are not a match. The modified preference classes are then applied to the print job requests and then, after completion of the order process, the respective print shop forwards the remaining print job requests as print jobs to a production device such as the prepress department and a printing machine, which then completes these print jobs. This ensures that based on the print job forecasts, the actual print jobs offered for processing in the print shop, and the preferences defined by the print shop, the print shop processes the matching print jobs. On the one hand, this ensures that the print jobs can be processed from a technical point of view because all print jobs are feasible; on the other hand, it ensures that processing them makes sense from an economic point of view because it is the print shop that defines the preferences and the print shop will select the preferences in such a way that they will not miss profitable print jobs available in the market.

A first embodiment of the invention envisages that in an offer optimizer, the computer assesses preference classes which have been assessed to be a match in accordance with the incidence of offered print jobs and filters out preference classes of a low incidence. This step is expediently carried out after the application of the exclusion filter. This step provides the print shop with a targeted way of filtering out preference classes that do not occur frequently. For this purpose, a desired incidence may be defined as a minimum, for instance in the form of percentages such as 10%, to filter out all preference classes of print jobs with an incidence of less than 10%. Preference classes of print jobs of a lower incidence may generally not be processed as profitably as preference classes of a higher incidence because a lower incidence means that frequent print job changes need to be made. In contrast, preference classes of print jobs of a higher incidence include many print jobs which have been combined in accordance with their similarities so multiple print jobs may successively be printed with only minor changes and short set-up periods.

A further embodiment of the invention envisages that in a job optimizer, the computer compares the preference classes which have been assessed to be a match to print jobs subsequently pending for being processed in the print shop and calculates revised preference classes as a function of the result of the comparison. The job optimization step is expediently done either following the exclusion filter or following the offer optimizer. In such a case, a comparison is made between the preference classes that have previously been assessed to be a match and the actual print jobs pending for being processed in the print shop, and the preference classes for the print jobs are additionally adapted in accordance with the result of the comparison. This increases the accuracy of the clustering into preference classes because actual pending print jobs are likewise taken into consideration when the preference classes are created. In this way, the preference classes are reliably adapted if the discrepancy between the job forecasts and the actual print jobs on offer at the moment was found to be too great.

A further embodiment of the present invention envisages that the preferences of the print shop include at least one of the features such as utilized capacity, available machinery, cost structure of the print shop, and current supply of consumables. The more of these features there are in the preferences, the more accurately the preference classes may be adapted to find the print jobs that actually match the profile of the print shop. This in turn means that the print jobs that the print shop filters out among the print jobs which are actually pending are definitely a match. The preferences of the print shop include the technical equipment in the form of machinery, the utilization of the capacity of the print shop, the cost structure of the print shop, and the current supplies of consumables. In addition, the qualifications of the operating staff of the machinery may be taken into consideration because some print jobs, especially ones with special finishes, require specially trained operating staff.

It is advantageously further envisaged that the preference classes for print jobs include at least one parameter such as format, colors, post-press operations, printing substrate characteristics, printing process, number of prints, or product class. In order to be able to filter out the matching print jobs among the pending print jobs using the preference classes, the print jobs need to be compared to the data of the preference classes. In this context, the data of print jobs such as format, colors, post-press processing, characteristics of the printing substrate, printing processes, number of prints, or product class play an important part, reducing the variance even further in this way and thus increasing the accuracy the more parameters the preference classes include.

It is advantageously further envisaged that a product class in turn is at least characterized by a printed product such as a business card, a flyer, a poster, or a pharmaceutic packaging. In this way, the desired printed products are in turn included into the preference classes for print jobs in the form of a product class so the print shop is in particular assigned the matching printed products in a targeted way through the calculation of the preference classes.

In addition, it is envisaged that a printed product is described by at least one parameter such as printing substrate, multicolor or black and white, post-press processing. The printed products of the product classes are in turn described in more detail by the aforementioned parameters, so that the printed products may be separated from one another and only those printed products which a print shop actually wants are included in the product classes and the product classes in turn describe the preference classes of the print shop in a suitable way. Due to this stepped hierarchy the preference classes are successively tailored to the print shop to avoid unnecessary print job variance.

A further embodiment of the invention envisages that in the first filtering step using the filter for excluding non-matching print jobs, in a first step the computer compares the incidence of color sets with the preferences of the print shop and, in a second step, the computer compares the incidence of the utilized printing substrates with the preferences of the print shop. The first filtering step of the filter for excluding print jobs is subdivided into two steps: a first one to compare the incidence of color sets to the preferences of the print shop and a second step to compare the remaining print jobs to the corresponding preferences of the print shop in terms of the incidence of the utilized printing substrates. In this way, the preferences of the print shops are compared to the job forecasts step by step and non-matching print jobs are filtered out by the two steps in the filter for excluding non-matching print jobs. This filter for excluding non-matching print jobs may be further refined by a third step in which the computer compares the incidence of numbers of prints to the preferences of the print shop. It goes without saying that further steps are conceivable; this depends on the number and type of the preferences provided by the print shop. The more preferences the print shop provides, the more steps the filter for excluding non-matching print jobs will apply and the more non-matching print jobs will be filtered out from among the job forecasts. However, one must bear in mind that a print shop should not provide too many preferences, in particular preferences which may contradict one another, because this would cause nearly all print jobs to be filtered out in the end and would possibly even result in an empty set. It is therefore important for the print shop to provide preferences that make sense.

Other features which are considered as characteristic for the invention are set forth in the appended claims.

Although the invention is illustrated and described herein as embodied in a method of manufacturing printed products with variance reduction, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The figure of the drawing is a flow chart of the method of the invention running on a computer and involving a computer and a printing machine in a print shop.

### DETAILED DESCRIPTION OF THE INVENTION

Referring now in detail to the single figure of the drawing, there is seen a computer 1 and a printing machine 2 which are merely used to simplify the representation of the present invention. In practice, the method may in particular be implemented on a centralized computer 1, which may be located in an Internet cloud. In such a case, a corresponding number of interfaces even with a number of print shops and multiple printing machines 2 is provided. Further production machinery 2 such as prepress machinery, platesetters, and post-press equipment may be included. However, the number of printing machines 2 and the types of the production machinery are irrelevant to understanding the present invention.

As shown in the figure, the computer 1 receives print job forecasts AP and preferences P of a print shop through two interfaces. Print job forecasts AP are based on patterns recognized in the past on the one hand and on the actual current framework and conditions on the other hand. The preferences P of the print shop are provided by the print shop itself and include parameters and features that may characterize a print job A. The preferences P further include the printed products manufacturing process, which the print shop provides on the basis of its machinery, cost structure, and skills of the operating staff. Then the computer 1 applies an exclusion filter F1 to make a first comparison in which the print job data from the print job forecast AP is compared to the data on the preferences P provided by the print shop. Non-matching print jobs A are then filtered out by the exclusion filter F1 and first preference classes are created out of the remaining print jobs A.

Subsequently, the created preference classes PK are fed to an offer optimizer O1. This offer optimizer O1 sorts the preference classes in terms of the print job requests that have a higher incidence. In this case a print shop may define a desired minimum incidence, causing all preference classes PK that do not correspond to the desired minimum incidence to be filtered out. Then the preference classes PK that have not been filtered out are fed to a job optimizer O2, which compares the preference classes PK that have not been filtered out so far with print jobs A that are actually already pending in the print shop. The preference classes PK that are not a match herein are in turn filtered out. The remaining preference classes PK are then in turn compared to print job requests AA in a job comparison F2 and the print job requests AA that remain in this step are electronically forwarded to the print shop. Then a decision may be made on the print job requests AA in the print shop, preferably using a software menu. The accepted print job requests AA are then accepted as print jobs A and they are forwarded to the production machinery in the print shop such as the printing machine 2.

In this way, the variance of print jobs A which are processed on the printing machine 2 is reduced to the extent desired by the print shop to ensure that only print jobs A that make sense or may actually be processed by the print shop in a particularly profitable way are processed by the printing machine 2. Thus the processing of print jobs A on the printing machine 2 is optimized, factoring in the actually pending print jobs A, the forecast for print jobs AP, the print job requests AA, and the preferences P of a print shop.

The following is a summary list of reference numerals and the corresponding structure which is also used in the above description of the invention.

### LIST OF REFERENCE SYMBOLS

1 computer
2 printing machine
F1 exclusion filter
F2 job comparison
O1 offer optimizer
O2 job optimizer
A print jobs
AA print job request
AP print job forecast
P preferences of a print shop
PK preference classes

1. A method of manufacturing printed products from print job requests by using at least one computer and at least one production machine, the method comprising:
supplying the computer with job forecasts of print jobs through at least one interface and supplying the computer with preferences of a print shop through the at least one interface or through a further interface;
using the computer to utilize an exclusion filter to filter out non-matching print jobs by comparing the preferences of the print shop to the job forecasts and to create preference classes for print jobs based on non-excluded print jobs;
supplying the computer with data of print job requests through the at least one interface;
using the computer to compare the data of the print job requests to the calculated preference classes of the print jobs to filter out non-matching print job requests;
using the computer to forward only remaining, matching print job requests to the at least one production machine of the print shop; and
using the at least one production machine of the print shop to accept the print job requests as print jobs and process the print jobs on the production machine to manufacture the printed products.

2. The method according to claim 1, which further comprises using an offer optimizer of the computer to assess preference classes having been assessed to be a match in terms of an incidence of offered print jobs, and filtering out preference classes of a low incidence.

3. The method according to claim 2, which further comprises using a job optimizer of the computer to compare the preference classes having been assessed to be a match to print jobs pending for processing in the print shop and calculating revised preference classes as a function of a comparison result.

4. The method according to claim 1, which further comprises providing the at least one interface of the computer as network connections to the Internet or intranet.

5. The method according to claim 1, which further comprises including at least one of capacity, available machinery, cost structure of the print shop and current supply of consumables in the preferences of the print shop.

6. The method according to claim 1, which further comprises including at least one parameter selected from format, colors, post-press processing, properties of a printing substrate, printing process, number of prints or product class in the preference classes for print jobs.

7. The method according to claim 6, which further comprises selecting at least one printed product including a business card, a flyer, a poster, or a pharmaceutical packaging to be in the product class.

8. The method according to claim 7, which further comprises describing a printed product by at least one parameter selected from printing substrate, multicolor or black and white or post-press processing.

9. The method according to claim 1, which further comprises carrying out the filtering step with the exclusion filter to filter out non-matching print jobs by using the computer to compare an incidence of color sets to the preferences of the print shop in a first step and to compare an incidence of utilized printing substrates to the preferences of the print shop in a second step.

10. The method according to claim 9, which further comprises using the computer to compare an incidence of numbers of prints to the preferences of the print shop in a third step.
